(19) United States
(12) Patent Application Publication
(10) Pub. No.: US 2023/0208598 A1
(43) Pub. Date: Jun. 29, 2023

(54) QCL ASSUMPTIONS FOR COMBINED SINGLE-DCI AND MULTI-DCI MULTI-TRP

(71) Applicant: QUALCOMM Incorporated, San Diego, CA (US)

(72) Inventors: Mostafa KHOSHNEVISAN, San Diego, CA (US); Yitao CHEN, San Diego, CA (US); Xiaoxia ZHANG, San Diego, CA (US); Yan ZHOU, San Diego, CA (US); Ruiming ZHENG, Beijing (CN); Tao LUO, San Diego, CA (US)

(21) Appl. No.: 17/996,448

(22) PCT Filed: Apr. 24, 2020
(86) PCT No.: PCT/CN2020/086626

§ 371 Date: Oct. 18, 2022

(51) Int. Cl. H04L 5/00

(52) U.S. Cl. CPC H04L 5/0053

(57) ABSTRACT

Certain aspects of the present disclosure provide techniques for quasi-colocation (QCL) assumptions, such as QCL assumptions for combined single-DCI (downlink control information) and multi-DCI mTRP (multiple transmission reception point) scenarios. A method that may be performed by a user equipment (UE) includes receiving signaling configuring the UE with a first index value associated with a first plurality of control resource sets (CORESETS) and a second index value associated with a second plurality of CORESETS. The UE may receive at least one medium access control (MAC) control element (CE) that activates a set of transmission configuration indicator (TCI) states, indicates one of the first or second index values, and that maps at least one TCI codepoint in downlink control information (DCI) to two TCI states. The UE may determine one or more TCI states to use for receiving one or more transmissions based, at least in part, on the mapping.

### BACKGROUND

### Field of the Disclosure

Aspects of the present disclosure relate to wireless communications, and more particularly, to techniques for quasi-colocation (QCL) assumptions, such as QCL assumptions for combined single-DCI (downlink control information) and multi-DCI mTRP (multiple transmission reception point) scenarios.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved for quasi-colocation (QCL) assumptions, such as QCL assumptions for combined single-DCI (downlink control information) and multi-DCI mTRP (multiple transmission reception point) scenarios.

Certain aspects of the subject matter described in this disclosure can be implemented in a method for wireless communication by a user equipment (UE). The method generally includes receiving signaling configuring the UE with a first index value associated with a first plurality of control resource sets (CORESETS) and a second index value associated with a second plurality of CORESETS. The method generally includes receiving at least one medium access control (MAC) control element (CE) that activates a set of transmission configuration indicator (TCI) states, indicates one of the first or second index values, and maps at least one TCI codepoint in downlink control information (DCI) to two TCI states. The method generally includes determining one or more TCI states to use for receiving one or more transmissions based, at least in part, on the mapping.

Aspects of the present disclosure provide means for, apparatus, processors, and computer-readable mediums for performing the methods described herein.

Aspects of the present disclosure provide means for, apparatus, processors, and computer-readable mediums for performing techniques and methods that may be complementary to the operations by the UE described herein, for example, by a BS.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 is a call flow diagram illustrating example signaling for a single transmission reception point (TRP) physical downlink shared channel (PDSCH) quasi-colocation (QCL) assumption, in accordance with certain aspects of the present disclosure.

FIG. 5 is a call flow diagram illustrating example signaling for a multiple downlink control information (mDCI) multiple TRP (mTRP) PDSCH QCL assumption, in accordance with certain aspects of the present disclosure.

FIG. 6 is an example mDCI mTRP scenario, in accordance with certain aspects of the present disclosure.

FIG. 7A is an example transmission configuration indicator (TCI) codepoint mapping to a single TCI state for a first control resource set (coreset) pool index value in an mDCI mTRP scenario, in accordance with certain aspects of the present disclosure.

FIG. 7B is an example TCI codepoint mapping to a single TCI state for a second coreset pool index value in an mDCI mTRP scenario, in accordance with certain aspects of the present disclosure.

FIG. 8 is a call flow diagram illustrating example signaling for a single-DCI mTRP PDSCH QCL assumption, in accordance with certain aspects of the present disclosure.

FIG. 9 is an example single-DCI mTRP scenario, in accordance with certain aspects of the present disclosure.

FIG. 10A is an example single-DCI mTRP scenario with spatial division multiplexing (SDM) of the TRPs, in accordance with certain aspects of the present disclosure.

FIG. 10B is an example single-DCI mTRP scenario with frequency division multiplexing (FDM) of the TRPs, in accordance with certain aspects of the present disclosure.

FIG. 10C is an example single-DCI mTRP scenario with time division multiplexing (TDM) of the TRPs, in accordance with certain aspects of the present disclosure.

FIG. 11 is an example TCI codepoint mapping to one or two TCI state(s) in a single-DCI mTRP scenario, in accordance with certain aspects of the present disclosure.

FIG. 12 is a flow diagram illustrating example operations for wireless communication by a UE, in accordance with certain aspects of the present disclosure.

FIG. 13 illustrates example QCL assumptions for an example combined single-DCI and mDCI mTRP scenario, in accordance with certain aspects of the present disclosure.

FIGS. 14A-G illustrates example scenarios for processing or dropping PDSCH based on a number of TCI states indicated by DCIs and a number of TCI states supported by the UE, in accordance with aspects of the present disclosure.

FIG. 15 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for quasi-colocation (QCL) assumptions, such as QCL assumptions for combined single-DCI (downlink control information) and multi-DCI mTRP (multiple transmission reception point) scenarios.

In single-DCI mTRP, one DCI is sent to indicate multiple QCL assumptions for a physical downlink shared channel (PDSCH) transmission from multiple TRPs. In some cases, the DCI can schedule PDSCH repetitions in spatial layers, frequency, and/or time. A transmission configuration indicator (TCI) codepoint (e.g., of DCI) may be mapped (e.g., by medium access control (MAC) control element (CE)) to multiple (e.g., two) TCI states.

In mDCI mTRP, multiple TRPs send DCIs to indicate the QCL assumptions for PDSCH transmission from the TRPs. The control resource set (CORESET) for the DCIs may be associated with different CORESET pool index values, and the different CORESET pool index values associated with separate mappings of TCI codepoints to TCI states, with each TCI codepoint mapped to a single TCI state.

In combined single-DCI and mDCI mTRP scenarios, a UE may be configured with both the different CORESET pool index values and also with a mapping of TCI codepoints with one or more TCI codepoints mapped to multiple TCI states.

The following description provides examples of for QCL assumptions for combined single-DCI and mDCI mTRP scenarios in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

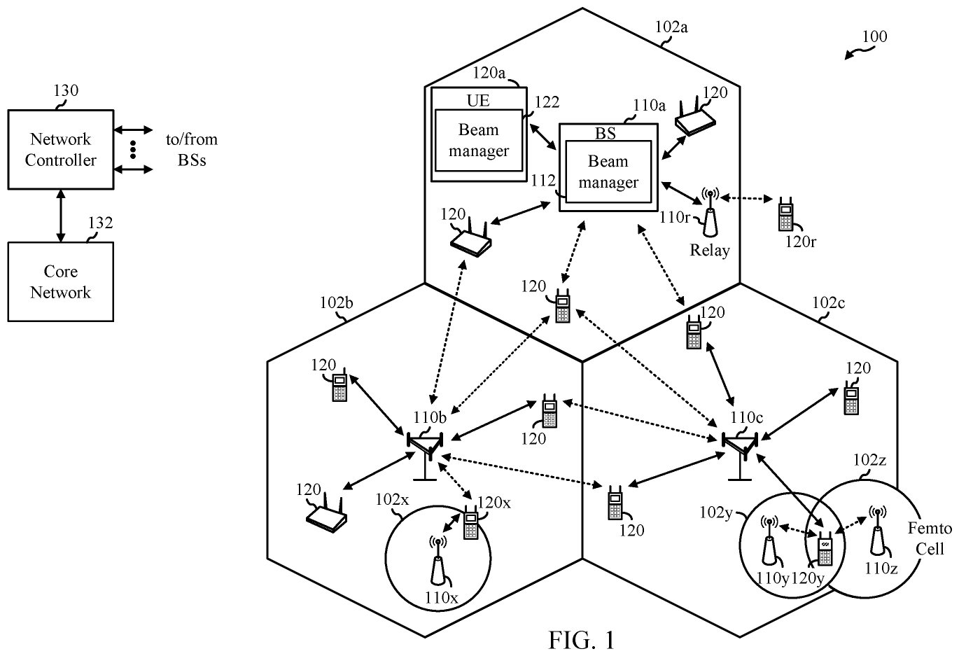

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

According to certain aspects, the BSs 110 and UEs 120 may be configured for combined single-DCI and mDCI mTRP. As shown in FIG. 1, the BS 110a includes a beam manager 112 that may be configured for combined single-DCI and mDCI mTRP, in accordance with aspects of the present disclosure. The UE 120a includes a beam manager 122 that may be configured for determining QCL assumptions for the combined single-DCI and mDCI mTRP scenario, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

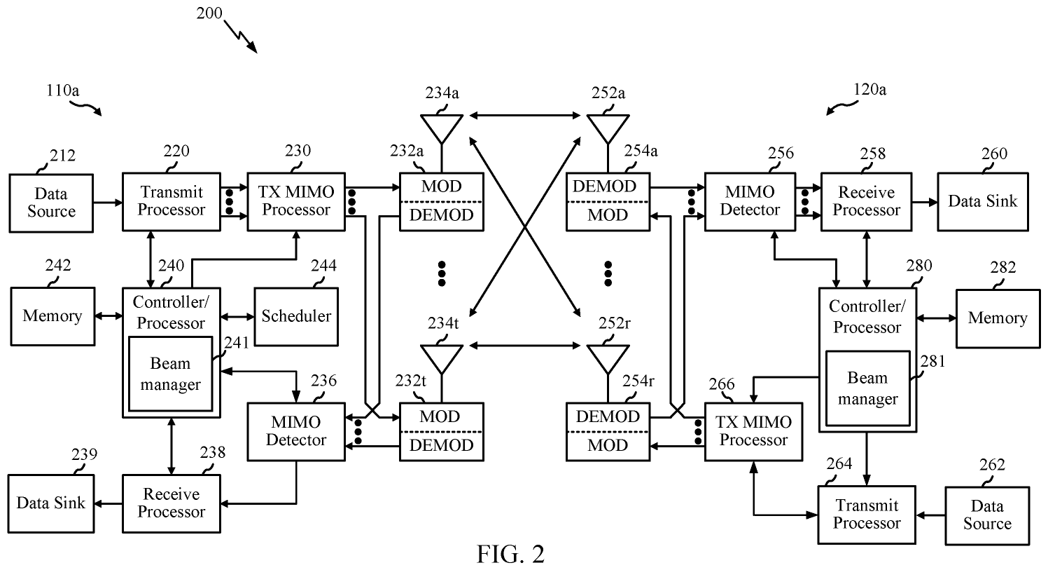

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a beam manager 241 that may be configured for combined single-DCI and mDCI mTRP, according to aspects described herein. As shown in FIG. 2, the controller/processor 280 of the UE 120a has a beam manager 281 that may be configured for QCL assumptions for combined single-DCI and mDCI mTRP scenarios, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

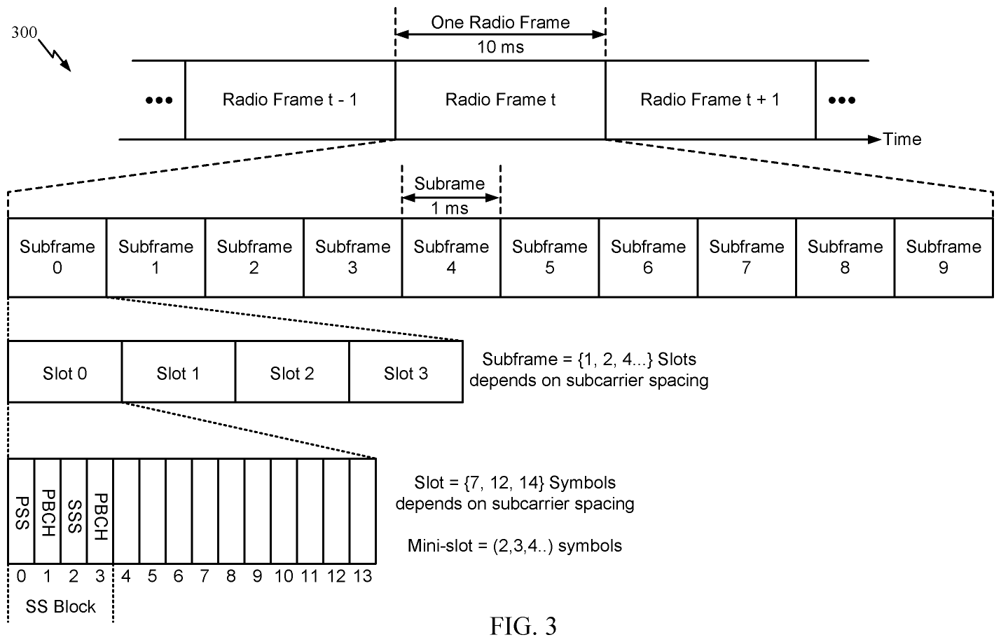

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

### Example QCL Assumption for Single-TRP PDSCH

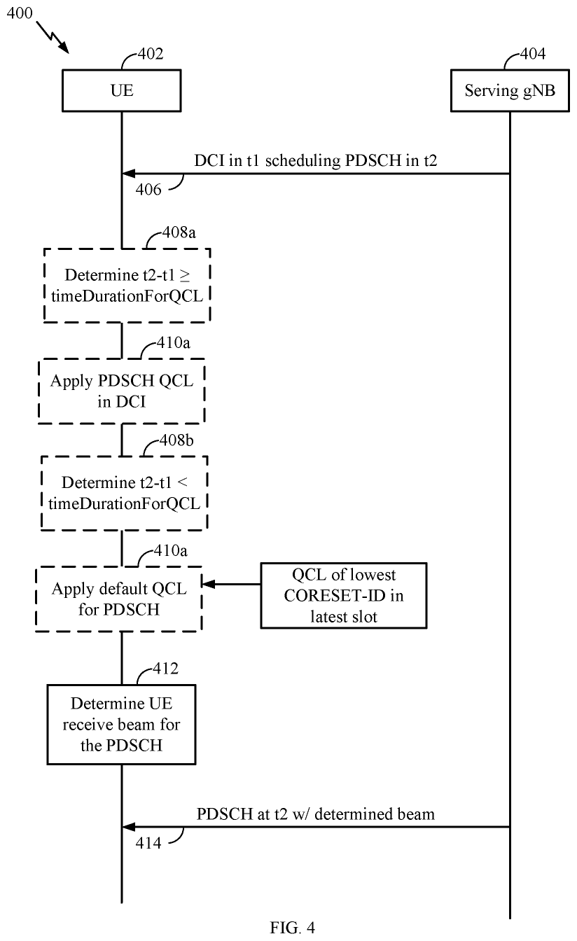

In certain systems (e.g., Release 15 systems), a set of TCI states (e.g., up to 8 TCI states) can be activated for PDSCH. As shown in FIG. 4, at 406, the UE 402 receives a DCI (with the last symbol of the DCI at t1) from the BS 404 scheduling a PDSCH (with the first symbol of the PDSCH at t2). A TCI field in the DCI may indicate a TCI state for the scheduled PDSCH.

The UE 402 may apply the indicated TCI state or a default QCL assumption, based on whether a time duration between the scheduled PDSCH and the DCI satisfies a threshold. For example, the threshold may be a “timeDurationForQCL” threshold. The UE 402 may report the threshold (e.g., 14 or 28 OFDM symbols) to the BS 404 as a UE capability.

As shown in FIG. 4, if the UE 402 determines, at 408a, the time offset between the reception of the DCI and the corresponding PDSCH is equal to or larger than the threshold (e.g., timeDurationForQCL), then the UE 402 may apply the TCI state indicated in the DCI for the PDSCH at 410a. For example, the UE 402 can determine the receive beam for receiving the PDSCH based on the indicated TCI state at 412. This may be because the UE has enough time to decode the DCI and prepare the beam based on the indicated TCI state in the DCI before receiving the PDSCH.

If the UE 402 determines, at 408b, that the time offset is less than the threshold (e.g., timeDurationForQCL), then the UE 402 applies a default QCL assumption (e.g., QCL-TypeD) for the PDSCH at 410b. For example, the UE 402 can determine the receive beam for receiving the PDSCH based on the default QCL at 412.

The default QCL assumption for the PDSCH may be the QCL/TCI state of the control resource set (CORESET) associated with a monitored search space with the lowest CORESET identifier (ID) in the latest slot in which one or more CORESETs within the active BWP of the serving cell are monitored by the UE.

Stated otherwise, if all the TCI codepoints are mapped to a single TCI state and the offset between the reception of the DL DCI and the corresponding PDSCH is less than the threshold timeDurationForQCL, the UE may assume that the demodulation reference signal (DM-RS) ports of PDSCH of a serving cell are quasi co-located (QCL'd) with the RS(s) with respect to the QCL parameter(s) used for PDCCH QCL indication of the CORESET associated with a monitored search space with the lowest controlResourceSetId in the latest slot in which one or more CORESETs within the active bandwidth part (BWP) of the serving cell are monitored by the UE.

At 414, the UE 402 receives the PDSCH (at t2) from the BS 404 using the determined received beam.

### Example mTRP

In certain system, transmissions may be via multiple transmission configuration indicator (TCI) states. In some examples, a TCI-state is associated with a beam pair, antenna panel, antenna ports, antenna port groups, a quasi-colocation (QCL) relation, and/or a transmission reception point (TRP). Thus, multi-TCI state transmission may be associated with multiple beam pairs, multiple antenna panels, and/or multiple QCL relations which may be associated with one or more multiple TRPs. The TCI state indicates the QCL assumption that the UE may use for channel estimation.

In some examples, the TCI state may generally indicate to the UE an association between a downlink reference signal to a corresponding QCL type which may allow the UE to determine the receive beam to use for receiving a transmission. The QCL-type may be associated with a combination (e.g., set) of QCL parameters. In some examples, a QCL-TypeA indicates the ports are QCL'd with respect to Doppler shift, Doppler spread, average delay, and delay spread; QCL-TypeB indicates the ports are QCL'd with respect to Doppler shift, and Doppler spread; QCL-TypeC indicates the ports are QCL'd with respect to average delay and Doppler shift; and QCL-TypeD indicates the ports are QCL'd with respect to Spatial Rx parameter. Different groups of ports can share different sets of QCL parameters.

In some examples, for a multi-TCI state scenario, the same TB/CB (e.g., same information bits but can be different coded bits) is transmitted from multiple TCI states, such as two or more TRPs in multi-TRP scenario. The UE considers the transmissions from both TCI states and jointly decodes the transmissions. In some examples, the transmissions from the TCI states is at the same time (e.g., in the same slot, mini-slot, and/or in the same symbols), but across different RBs and/or different layers. The number of layers from each TCI state can be the same or different. In some examples, for the same codeword (i.e., the same transport block/codeblock) mTRP transmission, the modulation order may be the same. For an mTRP transmission involving different codewords (e.g., two codewords from the two TRPs), then the each codeword may be associated with a rank, modulation, and resource allocation (e.g., referred to as a multi-DCI based mTRP transmission). In some examples, the transmissions from the TCI states can be at different times (e.g., in two consecutive mini-slots or slots). In some examples, the transmissions from the TRPs can be a combination of the above.

### Example QCL Assumption for mDCI mTRP PDSCH

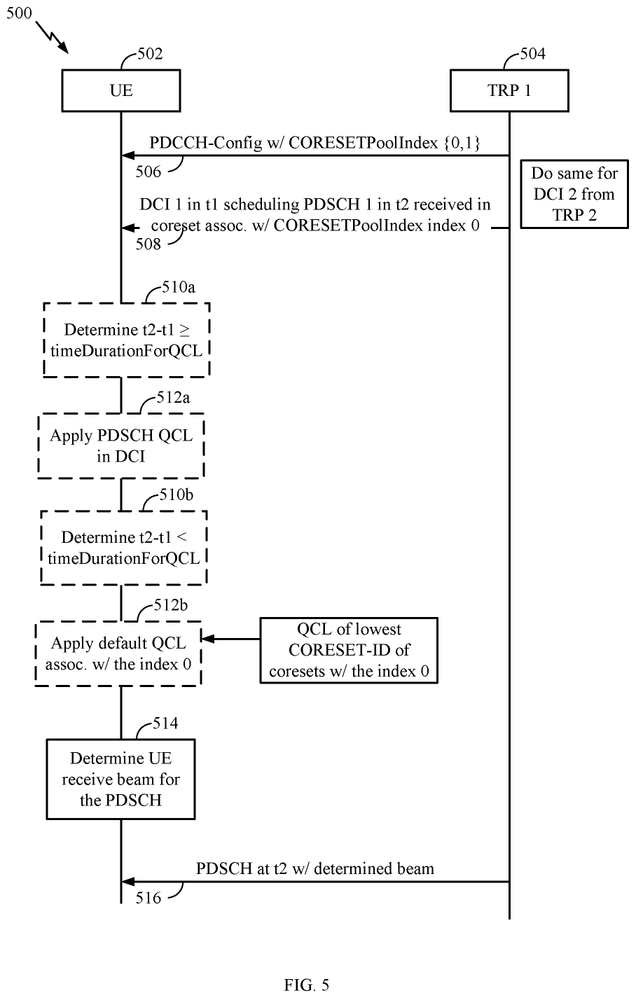

FIG. 5 is a call flow diagram illustrating example signaling 500 for a multiple DCI (mDCI) mTRP PDSCH QCL assumption.

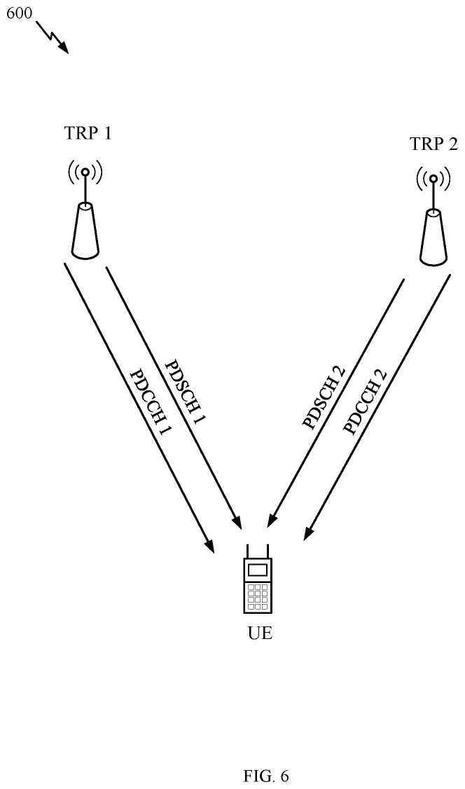

In certain systems (e.g., Release 16 systems), PDSCH may be transmitted by multiple TRPs and scheduled by multiple DCIs. For example, as shown in FIG. 6, in an example mTRP scenario 600, a first DCI (e.g., a DCI1) transmitted from a first TRP (e.g., TRP1) schedules a first PDSCH (e.g., PDSCH1) from the first TRP (e.g., TRP1) and a second DCI (e.g., a DCI2) transmitted from a second TRP (e.g., TRP2) schedules a second PDSCH (e.g., PDSCH2) from the second TRP (e.g., TRP2).

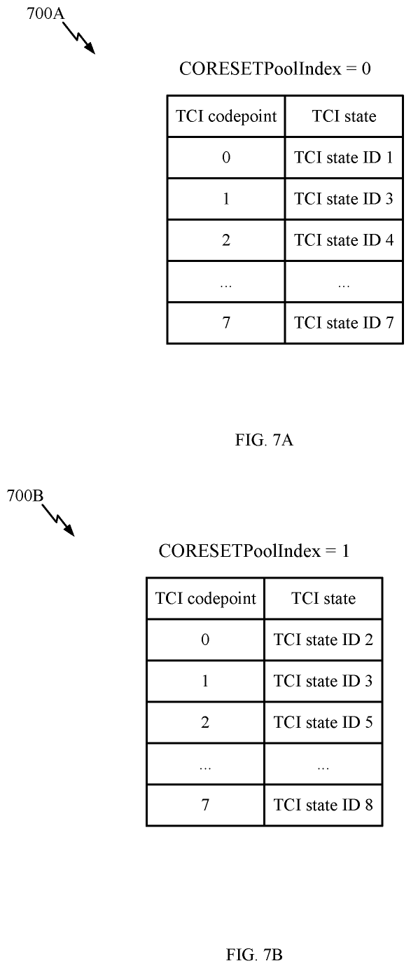

The TRP differentiation at the UE-side may be based on an index value associated with the DCIs. For example, the UE may receive a configuration of index values. A medium access control (MAC) control element (CE) may activate a set of TCI states (e.g., up to 8 TCI states) and map the set of activate TCI states to TCI codepoints in DCI. Each codepoint is mapped to a single TCI state. For example, 8 TCI states may be mapped to 8 TCI codepoints. The MAC-CE may also indicate a control resource set (CORESET) pool index value (e.g., CORESETPoolIndex value) associated with the active set of TCI states and the mapping. Each CORESET (e.g., up to 5 CORESETs) can be configured with a value of the CORESETPoolIndex, which may be 0 or 1. Thus, the CORESETS may be separated into two groups (e.g., a group of CORESETS associated with the CORESETPoolIndex value 0 and a group of CORESETS associated with the CORESETPoolIndex value 1). FIG. 7A and FIG. 7B illustrate examples mappings of TCI codepoints to TCI states for two CORESETPoolIndex values (0 and 1), respectively.

Thus, the UE interpretation of the TCI field of the DCI depends on the CORESETPoolIndex of the CORESET in which the DCI is detected. For example, when the UE detects a DCI in a CORESET configured with a CORESETPoolIndex value, the UE interprets the indicated TCI state based on the mapping associated with the same CORESETPoolIndex value.

As shown in FIG. 5, at 506, the UE 502 receives a configuration (e.g., a PDCCH-config RRC parameter) with the index values (e.g., CORESETPoolIndex values) from the TRP 1 504 (or TRP 2 or both). At 508, the UE 502 receives a DCI (at t1) from the BS 504 scheduling a PDSCH (at t2). The DCI may indicate a TCI state for the scheduled PDSCH. The DCI may be received in a CORESET associated with one of the CORESETPoolIndex values (e.g., 0 in the example in FIG. 5). Thus, the UE knows the CORESET and CORESETPoolIndex value associated with the DCI. The CORESETPoolIndex value of the CORESET in which the DCI is received may be used for different purposes, such as hybrid automatic repeated request (HARQ)-Ack codebook construction and transmission, PDSCH scrambling, and the like.

The UE 502 may apply the indicated TCI state or a default QCL assumption, based on whether a time duration between the scheduled PDSCH and the DCI satisfies a threshold. For example, the threshold may be a “timeDurationForQCL” threshold. The UE 502 may report the threshold (e.g., 14 or 28 OFDM symbols) to the BS 504 as a UE capability.

As shown in FIG. 5, if the UE 502 determines, at 510a, the time offset between the reception of the DCI 1 and the corresponding PDSCH is equal to or larger than the threshold (e.g., timeDurationForQCL), then the UE 502 may apply the TCI state indicated in the DCI for the PDSCH at 512a. For example, the UE 502 can determine the receive beam for receiving the PDSCH based on the indicated TCI state at 514.

If the UE 502 determines, at 510b, that the time offset is less than the threshold (e.g., timeDurationForQCL), then the UE 502 applies a default QCL assumption for the PDSCH at 512b. For example, the UE 502 can determine the receive beam for receiving the PDSCH based on the default QCL at 514.

The UE may maintain two default QCL assumption corresponding to the lowest CORESET ID within each CORESET group, as shown in FIG. 5. The two default QCL assumption may be a UE capability, which may be conditioned on another UE capability to receive two beams simultaneously (e.g., in frequency range (FR2), a millimeter wave (mmWave) frequency range). For example, the UE may support mDCI in FR2, but not support two simultaneous beams reception and/or not support two default QCL assumptions. In the example in FIG. 5, the default QCL assumption is the QCL assumption of the lowest CORESET-ID of the CORESETS with the index value 0.

Stated otherwise, if a UE configured by higher layer parameter PDCCH-Config that contains two different values of CORESETPoolIndex in ControlResourceSet, if the offset between the reception of the DL DCI and the corresponding PDSCH is less than the threshold timeDurationForQCL, the UE may assume that the DM-RS ports of PDSCH associated with a value of CORESETPoolIndex of a serving cell are QCL'd with the RS(s) with respect to the QCL parameter(s) used for PDCCH QCL indication of the CORESET associated with a monitored search space with the lowest CORESET-ID among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the UE.

At 516, the UE 502 receives the PDSCH (at t2) from the BS 504 using the determined received beam.

### Example QCL Assumption for Single-DCI mTRP PDSCH

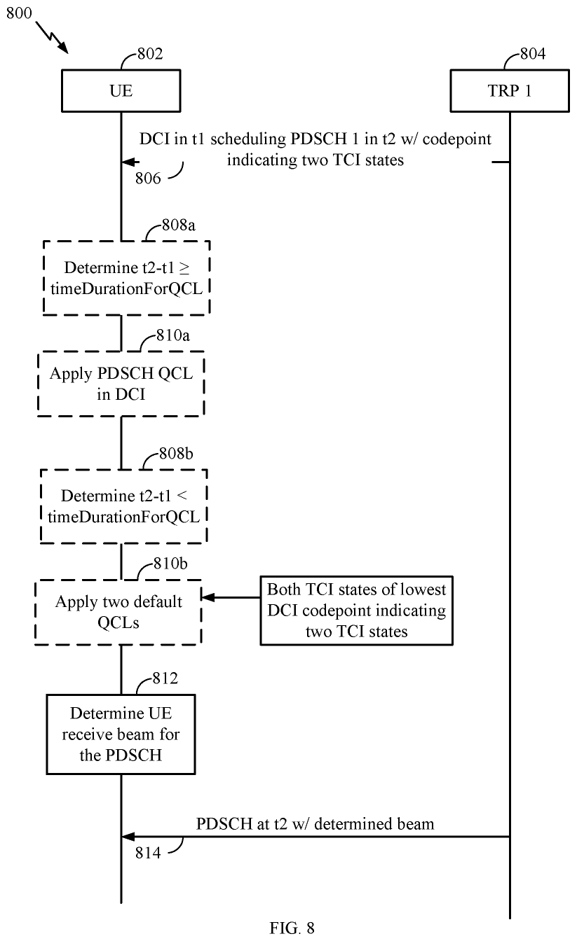

FIG. 8 is a call flow diagram illustrating example signaling 800 for a single-DCI mTRP PDSCH QCL assumption.

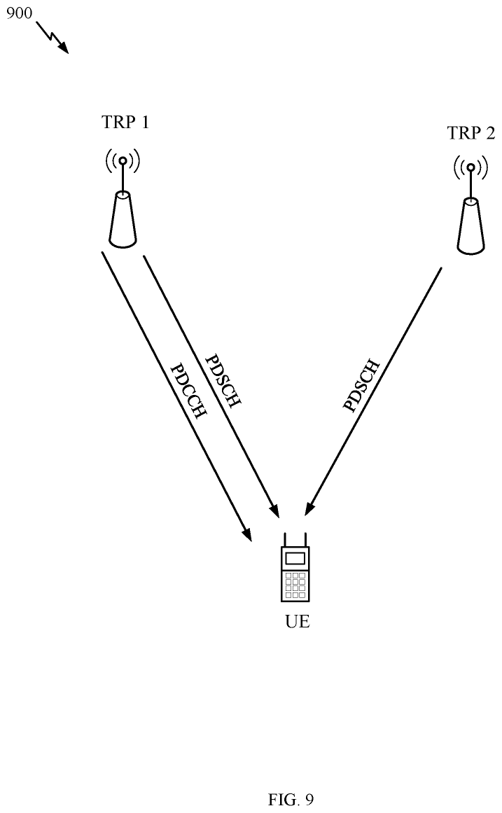

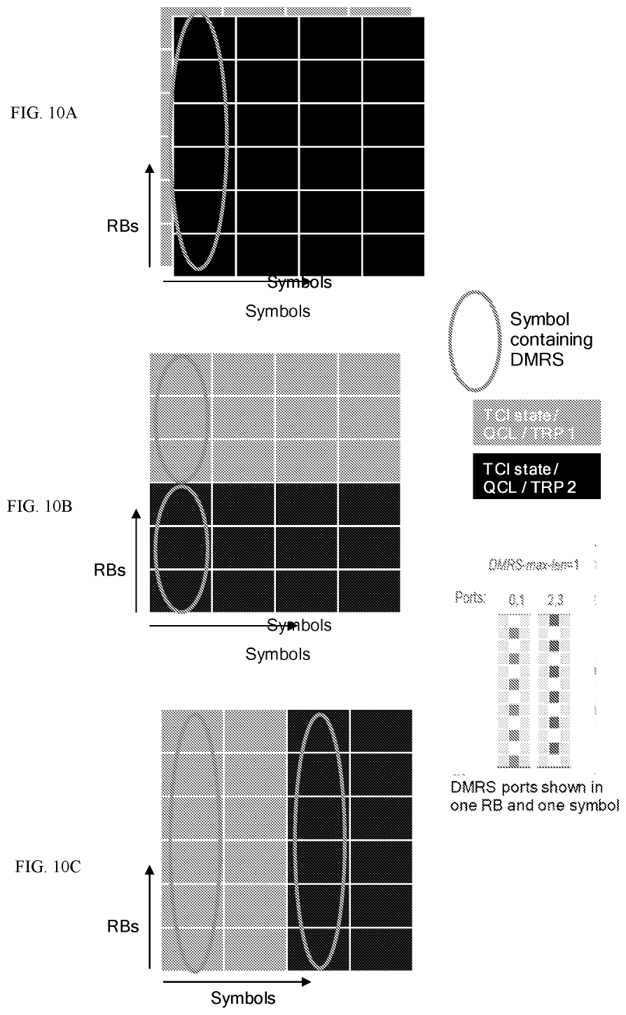

In certain systems (e.g., Release 16 systems), PDSCH may be transmitted by multiple TRPs and scheduled by a single DCI. As shown in FIG. 9, in an example single-DCI mTRP scenario 900, a DCI (e.g., on the PDCCH) transmitted from a first TRP (e.g., TRP A) schedules a PDSCH from both the first TRP (e.g., TRP A) and the second TRP (e.g., TRP B), where the PDSCH is a multi-state PDSCH. In some examples, the different TRPs transmit the PDSCH using spatial division multiplexing (SDM) as shown in FIG. 10A. For example, the different TRPs transmit using different spatial layers in overlapping RBs/symbols and with different TCI states. In some examples, the different TRPs transmit the PDSCH using frequency division multiplexing (FDM) as shown in FIG. 10B. For example, the different TRPs transmit using different RBs and with different TCI states. In some examples, the different TRPs transmit the PDSCH using time division multiplexing (TDM) as shown in FIG. 10C. For example, the different TRPs transmit using different OFDM symbols (e.g., in different mini-slots or slots) and with different TCI states. Different repetitions may be transmitted within a slot and/or different repetitions in different slots.

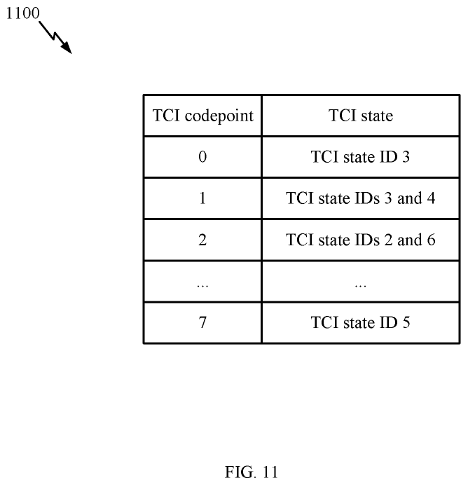

Each TCI codepoint in the DCI (e.g., corresponding to a TCI field value in the DCI) can indicate one TCI state or two TCI states for the PDSCH. Thus, the scheduled PDSCH can have two TCI states (e.g., corresponding to the two TRPs). A MAC-CE can activate a set of TCI states (e.g., up to 8 TCI states) and map the TCI states to TCI codepoints of DCI. FIG. 11 is an example TCI codepoint mapping to one or two TCI state(s) in a single-DCI mTRP scenario. The DCI then indicates one of the TCI states when scheduling a PDSCH. As shown in FIG. 8, at 806, the UE 802 receives a DCI (at t1) from the BS 804 scheduling a PDSCH (at t2) and the DCI has a codepoint that indicates two TCI states.

The UE 802 may apply the indicated TCI state or a default QCL assumption, based on whether a time duration between the scheduled PDSCH and the DCI satisfies a threshold. For example, the threshold may be a “timeDurationForQCL” threshold. The UE 802 may report the threshold (e.g., 14 or 28 OFDM symbols) to the BS 804 as a UE capability.

As shown in FIG. 8, if the UE 802 determines, at 808a, the time offset between the reception of the DCI and the corresponding PDSCH is equal to or larger than the threshold (e.g., timeDurationForQCL), then the UE 802 may apply the TCI state indicated in the DCI for the PDSCH at 810a. For example, the UE 802 can determine the receive beam for receiving the PDSCH based on the indicated TCI state at 812.

If the UE 802 determines, at 808b, that the time offset is less than the threshold (e.g., timeDurationForQCL), then the UE 802 applies a default QCL assumption for the PDSCH at 810b. For example, the UE 802 can determine the receive beam for receiving the PDSCH based on the default QCL at 814.

The UE may maintain two default QCL assumptions. The two default QCL assumption may be a UE capability, which may be conditioned on another UE capability to receive two beams simultaneously (e.g., in frequency range (FR2), a millimeter wave (mmWave) frequency range). For example, the UE may support mDCI in FR2, but not support two simultaneous beams reception and/or not support two default QCL assumptions. The default QCL assumption may correspond to the TCI states of lowest DCI codepoint of the DCI codepoints indicating two TCI states.

Stated otherwise, if the offset between the reception of the DL DCI and the corresponding PDSCH is less than the threshold timeDurationForQCL and at least one configured TCI states for the serving cell of scheduled PDSCH contains the ‘QCL-TypeD’, and at least one TCI codepoint indicates two TCI states, the UE may assume that the DM-RS ports of PDSCH of a serving cell are QCL'd with the RS(s) with respect to the QCL parameter(s) associated with the TCI states corresponding to the lowest codepoint among the TCI codepoints containing two different TCI states.

At 814, the UE 802 receives the PDSCH (at t2) from the BS 804 using the determined received beam.

### Example Combined Single-DCI and mDCI mTRP

In some systems, a UE may be configured for both single-DCI mTRP operations and mDCI mTRP operation. For examples, the UE may be configured with different CORESET pool index values and the UE may also receive MAC-CE that maps one or more TCI codepoints to multiple TCI states.

Accordingly, what is needed are techniques and apparatus for combined single-DCI and mDCI mTRP scenarios.

### Example QCL Assumptions for Combined Single-DCI and mDCI mTRP Scenarios

Aspects of the present disclosure provide techniques for quasi-colocation (QCL) assumptions, such as QCL assumptions for combined single-DCI (downlink control information) and multi-DCI (mDCI) mTRP (multiple transmission reception point) scenarios. For example, aspects provide techniques for a use equipment (UE) to determine the set of active transmission configuration indicator (TCI) states, which medium access control (MAC) control element (CE) to follow, how to handle when a total number of TCI states across two physical downlink shared channels (PDSCHs) is greater than a supported number of TCI states by the UE, and how to determine the default QCL assumptions.

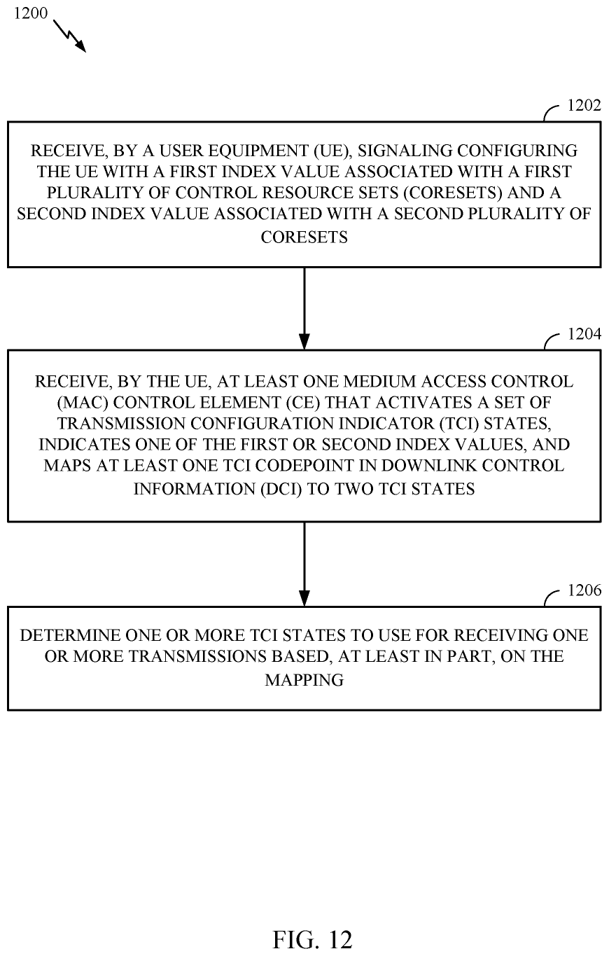

FIG. 12 is a flow diagram illustrating example operations 1200 for wireless communication, in accordance with certain aspects of the present disclosure. The operations 1200 may be performed, for example, by a UE (e.g., the UE 120a in the wireless communication network 100). The operations 1200 may be implemented as software components that are executed and run on one or more processors (e.g., controller/processor 280 of FIG. 2). Further, the transmission and reception of signals by the UE in operations 1200 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1200 may begin, at 1202, by receiving signaling configuring the UE with a first index value (e.g., a first CORESETPoolIndex value) associated with a first plurality of control resource sets (CORESETS) and a second index value (e.g., a second CORESETPoolIndex value) associated with a second plurality of CORESETS.

At 1204, the UE may receive at least one MAC-CE that activates a set of TCI states, indicates one of the first or second index values, and maps at least one TCI codepoint in DCI to two TCI states.

At 1206, the UE may determine one or more TCI states to use for receiving one or more transmissions based, at least in part, on the mapping.

According to certain aspects, when a UE is configured with two different CORESET pool index values in different CORESETs in a serving cell and the UE receives a MAC-CE that activates a set of TCI states and maps at least one TCI codepoint to two TCI states, the UE assumes the MAC-CE corresponds to both of the CORESET pool index values. In this case, the UE interprets the TCI codepoint in a DCI based on the MAC-CE whether the DCI is received in a CORESET configured with either of the CORESET pool index value. This can enable mDCI operation in which each DCI can schedule a PDSCH with one or two TCI states (e.g., a combined mDCI+single-DCI mTRP scenario).

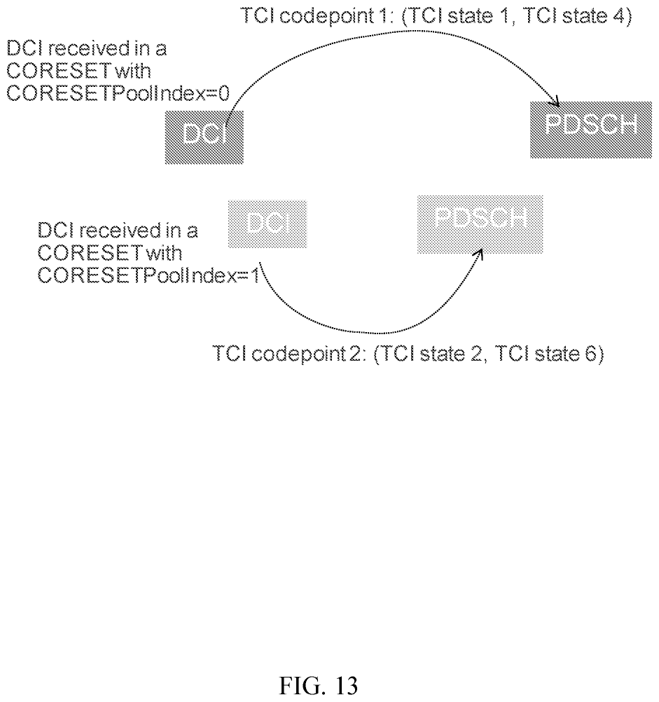

In an illustrative example shown in FIG. 13, a UE may receive a MAC-CE with the example mapping shown in FIG. 11. As shown in FIG. 13, the UE may receive a DCI in a CORESET associated with CORESETPoolIndex 0 that indicates the TCI codepoint 1, which the UE interprets as indicating the TCI state 1 ID 3 and the TCI state ID 4 according to the MAC-CE. The UE also receive another DCI in a CORESET associated with CORESETPoolIndex 1 that indicates the TCI codepoint 2, which the UE interprets as indicating the TCI state ID 2 and the TCI state ID 6 according to the same MAC-CE. When the scheduling offset between the DCIs and the PDSCH satisfies (e.g., is at or above) the threshold duration, then the UE uses the TCI state(s) indicated in the DCI to receive the PDSCH.

According to certain aspects, if the UE receives another MAC-CE (e.g., a second MAC-CE) that indicates a value of CORESETPoolIndex, the UE may update the set of activated TCI states and mapping to TCI codepoints only for the CORESETPoolIndex value indicated in the second MAC-CE. For the other CORESETPoolIndex value, the UE may continue to use the first MAC-CE. Alternatively, for the other CORESETPoolIndex value, the UE may assume the previous (e.g., original) set of activated TCI states and mapping to TCI codepoints (indicated by the first MAC-CE) is deactivated. The UE can receive yet another MAC-CE (e.g., a third MAC-CE) that indicates the other CORESETPoolIndex value and the UE can then update the set of activated TCI states and mapping to TCI codepoints for the other CORESETPoolIndex value (indicated in the third MAC-CE).

According to certain aspects, when a UE is configured with two different CORESET pool index values in different CORESETs in a serving cell, when the UE receives a MAC-CE that activates a set of TCI states and maps at least one TCI codepoint to two TCI states, the UE may drop one or more PDSCH transmissions that overlap in time. For example, when the number of TCI states indicated for PDSCHs in an overlapping symbol exceeds a threshold value the UE drop one or more PDSCHs. In some examples, the threshold number of TCI states is a fixed value (e.g. should not exceed 2 TCI states in total). In some examples, the threshold number of TCI may be based on UE capability (e.g., as indicated/determined from UE capability signalling).

The UE may determine the one or more PDSCHs to drop based on priority. In some examples, the priority is based on the index value associated with the CORESETS in which the DCIs scheduling the PDSCHs is received (e.g., based on the CORESETPoolIndex value). In some examples, the priority is based on the one or more TCI states indicated by the DCIs scheduling the PDSCHs. In some examples, the priority is based on a priority level of traffic data scheduled for transmission in the PDSCHs. For example, ultra-reliable low-latency communication (URLLC) traffic may have a higher priority than enhanced mobile broadband (eMBB) traffic.

According to certain aspects, the UE may report hybrid automatic repeat request (HARQ) feedback for the dropped PDSCH. In some cases, the PDSCH may be scheduled with repetitions. When PDSCH repetitions overlap, the UE may drop only the PDSCH that overlap. The UE may attempt to decode the other PDSCH repetitions. The UE may send a negative acknowledgment (NACK) if all PDSCH repetitions are dropped.

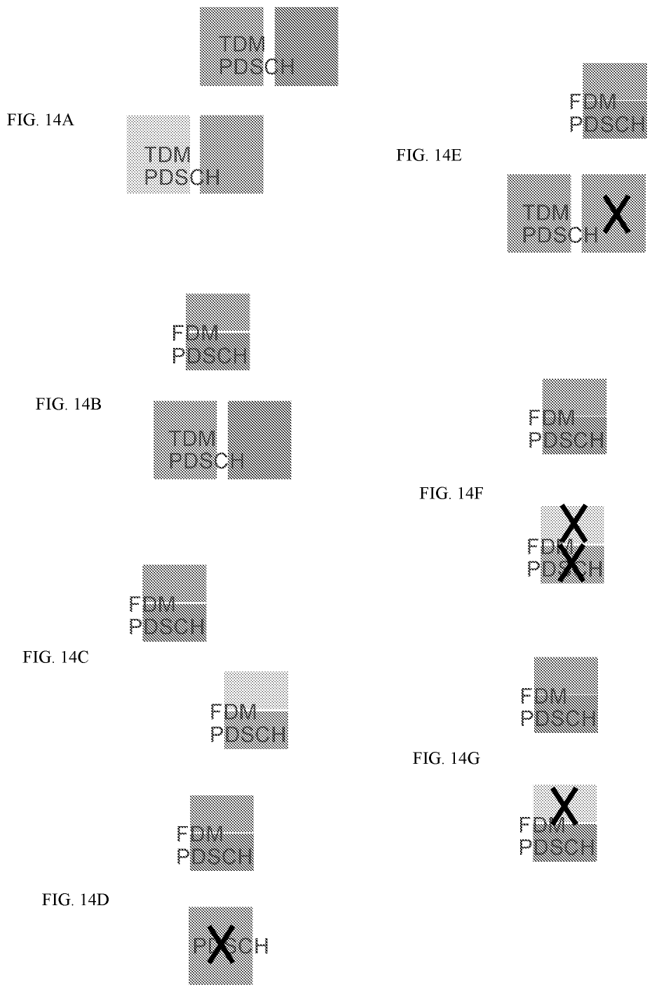

FIGS. 14A-G illustrates example scenarios for processing or dropping PDSCH based on a number of TCI states indicated by DCIs and a number of TCI states supported by the UE, in accordance with aspects of the present disclosure. In the example shown in FIGS. 14A-G, the threshold number of TCI states is 2. As shown, all of the PDSCHs in the FIGS. 14A, 14B, and 14C can be processed as in any overlapping symbol, no more than two TCI states are indicated. On the other hand, as shown in the FIGS. 14D-14G, one or more of the PDSCHs is dropped when more than two TCI states are indicated.

According to certain aspects, when a UE is configured with two different CORESET pool index values in different CORESETs in a serving cell and the UE receives a MAC-CE that activates a set of TCI states and maps at least one TCI codepoint to two TCI states, the UE may determine default QCL assumptions for PDSCH when the scheduling offset between the DCI and the scheduled PDSCH transmission is below a threshold duration.

In some examples, the UE maintains two default QCL assumptions corresponding to the lowest CORESET ID among the CORESETs with the same CORESETPoolIndex value monitored in the latest slot.

In some examples, the UE determines two default QCL assumptions based on the two TCI states corresponding to the lowest codepoint among the TCI codepoints containing two different TCI states. If TCI codepoints of DCI in CORESETs with CORESETPoolIndex=0 are different than TCI codepoints of DCI in CORESETs with CORESETPoolIndex=1 (e.g. if a second MAC-CE indicates a CORESETPoolIndex value), then TCI codepoints corresponding to one of the index values (e.g., CORESETPoolIndex=0) may be listed first followed by TCI codepoints corresponding to the other index value (e.g., CORESETPoolIndex=1) for purposes of determining the lowest codepoint among the TCI codepoints containing two different TCI states.

In some cases, the UE may indicate capability for more than two default QCL assumptions. In this case, the QCL assumptions for each CORESETPoolIndex value may be determined separately. If no TCI codepoints of DCI in CORESETs with a CORESETPoolIndex value indicates two TCI states, then one of the default QCL assumptions may be determined from the QCL assumptions corresponding to the lowest CORESET ID among the CORESETs with that CORESETPoolIndex value monitored in the latest slot. If at least one TCI codepoint of DCI in CORESETs with a CORESETPoolIndex value indicates two TCI states, two of the default QCL assumptions may be determined based on TCI states corresponding to the lowest codepoint among the TCI codepoints (that are associated with that CORESETPoolIndex value) containing two different TCI states. Depending on TCI codepoints associated with each CORESETPoolIndex value, one default QCL assumption may be determined for a first index value (e.g., CORESETPoolIndex=0) and two default QCL assumptions may be determined for the other index value (e.g., CORESETPoolIndex=1), i.e., three default QCL assumptions may be determined in total in this example.

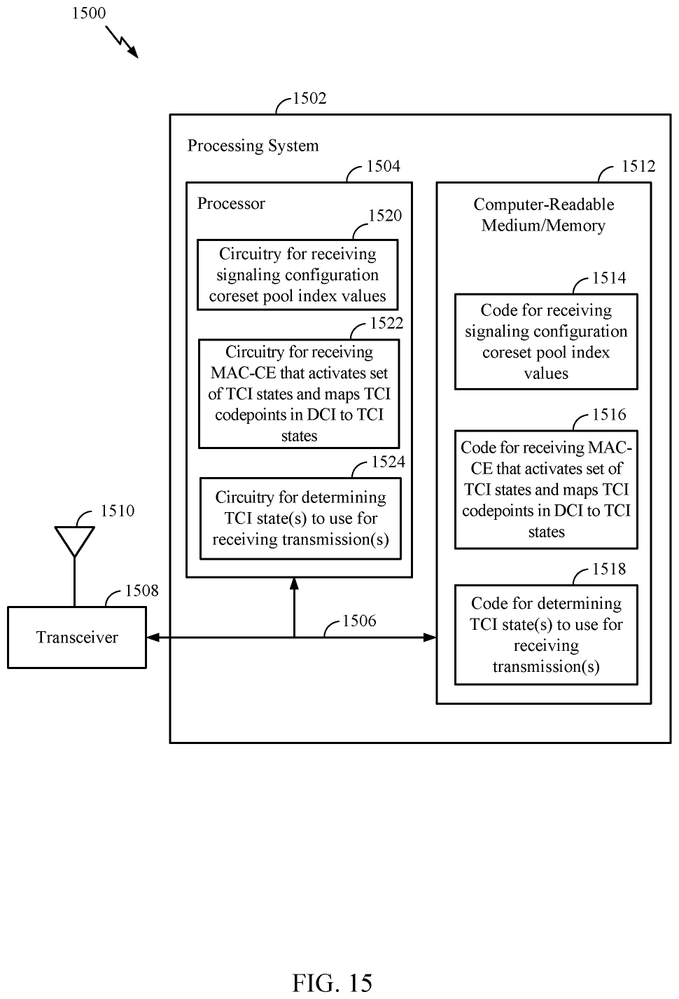

FIG. 15 illustrates a communications device 1500 that may include various components (e.g., corresponding to means-plus-function components) configured to perform operations for the techniques disclosed herein, such as the operations illustrated in FIG. 12. The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes a processor 1504 coupled to a computer-readable medium/memory 1512 via a bus 1506. In certain aspects, the computer-readable medium/memory 1512 is configured to store instructions (e.g., computer-executable code) that when executed by the processor 1504, cause the processor 1504 to perform the operations illustrated in FIG. 12, or other operations for performing the various techniques discussed herein for combined single-DCI and mDCI mTRP operation. In certain aspects, computer-readable medium/memory 1512 stores code 1514 for receiving signaling configuring the UE with a first index value associated with a first plurality of CORESETS and a second index value associated with a second plurality of CORESETS; code 1516 for receiving at least one MAC-CE that activates a set of TCI states, indicates one of the first or second index values, and maps at least one TCI codepoint in DCI to two TCI states, and/or code 1518 for determining one or more TCI states to use for receiving one or more transmissions based, at least in part, on the mapping, in accordance with aspects of the disclosure. In certain aspects, the processor 1504 has circuitry configured to implement the code stored in the computer-readable medium/memory 1512. The processor 1504 includes circuitry 1520 for receiving signaling configuring the UE with a first index value associated with a first plurality of CORESETS and a second index value associated with a second plurality of CORESETS; circuitry 1522 for receiving at least one MAC-CE that activates a set of TCI states, indicates one of the first or second index values, and maps at least one TCI codepoint in DCI to two TCI states, and/or circuitry 1524 for determining one or more TCI states to use for receiving one or more transmissions based, at least in part, on the mapping, in accordance with aspects of the disclosure.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 12.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a user equipment (UE), comprising:
receiving signaling configuring the UE with a first index value associated with a first plurality of control resource sets (CORESETs) and a second index value associated with a second plurality of CORESETs;
receiving at least one medium access control (MAC) control element (CE) that activates a set of transmission configuration indicator (TCI) states, wherein the MAC CE indicates the first index value or the second index value, and wherein the MAC CE includes a mapping that maps at least one TCI codepoint in downlink control information (DCI) to two TCI states; and
determining one or more TCI states to use for receiving one or more transmissions based, at least in part, on the mapping.

2. The method of claim 1, further comprising:
applying the mapping to TCI codepoints in DCI associated with both the first index associated with the first plurality of CORESETs and the second index value associated with the second plurality of CORESETs.

3. The method of claim 2, further comprising:
receiving a DCI in the first plurality of CORESETs or the second plurality of CORESETs, wherein the DCI indicates a TCI codepoint, wherein the DCI schedules a physical downlink shared channel (PDSCH) transmission, and wherein determining the one or more TCI states to use for receiving the one or more transmissions based on the mapping comprises determining the one or more TCI states for receiving the PDSCH transmission based on the mapping.

4. The method of claim 3, wherein determining the one or more TCI states for receiving the PDSCH transmission based on the mapping comprises determining the one or more TCI states indicated by the TCI codepoint in the DCI based on the mapping when a duration between the DCI and the PDSCH transmission is equal to or longer than a threshold duration.

5. The method of claim 1, further comprising:
receiving a second MAC CE, wherein the second MAC CE indicates the first index value or the second index values, wherein the second MAC CE activates a second set of TCI states, and wherein the second MAC CE includes a second mapping that maps one or more TCI codepoints in DCI to one or more TCI states;
updating the set of activated TCI states and the mapping of TCI codepoints to TCI states only for the first or second plurality of CORESETs associated with the first or second index value indicated in the second MAC CE; and
maintaining the original set of activated TCI states and the mapping of TCI codepoints to TCI states for the first or second plurality of CORESETs associated with the index value indicated in the first MAC CE.

6. The method of claim 1, further comprising:
receiving a second MAC CE, wherein the second MAC CE indicates the first index value or the second index values, wherein the second MAC CE activates a second set of TCI states, and wherein the second MAC CE includes a second mapping that maps one or more TCI codepoints in DCI to one or more TCI states;
updating the set of activated TCI states and the mapping of TCI codepoints to TCI states only for the first or second plurality of CORESETs associated with the first or second index value indicated in the second MAC CE; and
deactivating the original set of activated TCI states and mapping of TCI codepoints to TCI states for the first or second plurality of CORESETs associated with the first or second index value indicated in the first MAC CE.

7. The method of claim 1, further comprising:
receiving a first DCI in a first CORESET of the first plurality of CORESETs associated with the first index value, wherein the first DCI indicates a first TCI state, and wherein the first DCI schedules a first physical downlink shared channel (PDSCH) transmission;
receiving a second DCI in a second CORESET of the second plurality of CORESETS associated with the second index value, wherein the second DCI indicates a second TCI state, and wherein the second DCI schedules a second PDSCH transmission that overlaps in time with the first PDSCH transmission; and
processing or dropping the first and second PDSCH transmissions based on a number of TCI states indicated by the first and second DCIs.

8. The method of claim 7, wherein processing or dropping the first and second PDSCH transmissions based on the number of TCI states indicated by the first and second DCIs comprises dropping the first PDSCH transmissions, the second PDSCH transmission, or both the first and second PDSCH transmissions, when the number of TCI states indicated by the first and second DCIs in at least one symbol in which the first and second PDSCH transmissions overlap is equal to or greater than a threshold number of TCI states.

9. The method of claim 8, wherein the threshold number of TCI states comprises a fixed value.

10. The method of claim 8, wherein the threshold number of TCI states is based on a capability of the UE.

11. The method of claim 8, wherein dropping the first PDSCH transmissions, the second PDSCH transmission, or both the first and second PDSCH transmissions, when the number of TCI states indicated by the first and second DCIs in at least one symbol in which the first and second PDSCH transmissions overlap is equal to or greater than the threshold number of TCI states comprises:
determining to drop the first PDSCH transmission or the second PDSCH transmission based on a first priority associated with the first PDSCH transmission and a second priority associated with the second PDSCH transmission.

12. The method of claim 11, wherein the first priority of the first PDSCH transmission is based on the first index value associated with the first CORESET in which the first DCI is received, and wherein the second priority of the second PDSCH transmission is based on the second index value associated with the second CORESET in which the second DCI is received.

13. The method of claim 11, wherein the first priority of the first PDSCH transmission is based on a first one or more TCI states indicated by the first, and wherein the second priority of the second PDSCH transmission is based on a second one or more TCI states indicated by the second DCI.

14. The method of claim 11, wherein the first priority of the first PDSCH transmission is based on a first priority level of first traffic data scheduled for transmission in the first PDSCH transmission, and wherein the second priority of the second PDSCH transmission is based on a second priority level of second traffic data scheduled for transmission in the second PDSCH transmission.

15. The method of claim 7, further comprising reporting hybrid automatic repeat request (HARQ) feedback for the dropped first PDSCH transmission, second PDSCH transmission, or first and second PDSCH transmissions.

16. The method of claim 7, wherein, when the dropped PDSCH is scheduled with repetitions, the dropping comprises:
dropping only the one or more PDSCH repetitions that overlap the other PDSCH;
attempting to decode the other PDSCH repetitions; and
sending a negative acknowledgment if all PDSCH repetitions are dropped.

17. The method of claim 7, wherein processing or dropping the first and second PDSCH transmissions based on the number of TCI states indicated by the first and second DCIs comprises:
processing or dropping the first and second PDSCHs based on a number of TCI states indicated by the first and second DICs when a first duration between the first DCI and the first PDSCH transmission is equal to or longer than a threshold duration and a second duration between the second DCI and the second PDSCH transmission is equal to or longer than a threshold duration.

18. The method of claim 1, further comprising:
receiving a DCI that schedules a physical downlink shared channel (PDSCH) transmission, wherein the DCI is received in a CORESET of the first or second plurality of CORESETs associated with the first or second index value; and
when a duration between the DCI and the PDSCH transmission is shorter than a threshold duration, determining at least two default quasi-colocation (QCL) assumptions for receiving the PDSCH transmission.

19. The method of claim 18, wherein determining the at least two default QCL assumptions comprises determining the QCL assumptions corresponding to a lowest CORESET identifier (ID) among a plurality of CORESET IDs of the first or second plurality of CORESETs associated with the same index value that are monitored in a most recent slot.

20. The method of claim 18, wherein determining the at least two default QCL assumptions comprises determining the QCL assumptions corresponding to a lowest TCI codepoint among the at least one TCI codepoint that maps to two TCI states.

21. The method of claim 20, wherein determining the QCL assumptions corresponding to the lowest TCI codepoint among the at least one TCI codepoint that maps to two TCI states includes determining the lowest TCI codepoint among the at least one TCI codepoint that maps to two TCI states based on the mapping.

22. The method of claim 18, wherein determining the at least two default QCL assumptions comprises determining at least two default QCL assumptions for each index value separately when the UE supports a capability for more than two default QCL assumption.

23. An apparatus for wireless communication, comprising:
at least one processor; and
a memory coupled to the at least one processor, the memory comprising code executable by the at least one processor to cause the apparatus to:
receive signaling configuring the apparatus with a first index value associated with a first plurality of control resource sets (CORESETs) and a second index value associated with a second plurality of CORESETs;
receive at least one medium access control (MAC) control element (CE) that activates a set of transmission configuration indicator (TCI) states, wherein the MAC CE indicates the first index value or the second index value, and wherein the MAC CE includes a mapping that maps at least one TCI codepoint in downlink control information (DCI) to two TCI states; and
determine one or more TCI states to use for receiving one or more transmissions based, at least in part, on the mapping.

24. An apparatus for wireless communication, comprising:
means for receiving signaling configuring the apparatus with a first index value associated with a first plurality of control resource sets (CORESETs) and a second index value associated with a second plurality of CORESETs;
means for receiving at least one medium access control (MAC) control element (CE) that activates a set of transmission configuration indicator (TCI) states, wherein the MAC CE indicates the first index value or the second index value, and wherein the MAC CE includes a mapping that maps at least one TCI codepoint in downlink control information (DCI) to two TCI states; and
means for determining one or more TCI states to use for receiving one or more transmissions based, at least in part, on the mapping.

25. A computer readable medium storing computer executable code thereon for wireless communications, comprising:
code for receiving signaling configuring a user equipment (UE) with a first index value associated with a first plurality of control resource sets (CORESETs) and a second index value associated with a second plurality of CORESETs;
code for receiving at least one medium access control (MAC) control element (CE) that activates a set of transmission configuration indicator (TCI) states, wherein the MAC CE indicates the first index value or the second index value, and wherein the MAC CE includes a mapping that maps at least one TCI codepoint in downlink control information (DCI) to two TCI states; and
code for determining one or more TCI states to use for receiving one or more transmissions based, at least in part, on the mapping.

26. The apparatus of claim 23, further comprising:
applying the mapping to TCI codepoints in DCI associated with both the first index associated with the first plurality of CORESETs and the second index value associated with the second plurality of CORESETs.

27. The apparatus of claim 26, further comprising:
receiving a DCI in the first plurality of CORESETs or the second plurality of CORESETs, wherein the DCI indicates a TCI codepoint, wherein the DCI schedules a physical downlink shared channel (PDSCH) transmission, and wherein determining the one or more TCI states to use for receiving the one or more transmissions based on the mapping comprises determining the one or more TCI states for receiving the PDSCH transmission based on the mapping.

28. The apparatus of claim 27, wherein determining the one or more TCI states for receiving the PDSCH transmission based on the mapping comprises determining the one or more TCI states indicated by the TCI codepoint in the DCI based on the mapping when a duration between the DCI and the PDSCH transmission is equal to or longer than a threshold duration.

29. The apparatus of claim 23, further comprising:
receiving a second MAC CE, wherein the second MAC CE indicates the first index value or the second index values, wherein the second MAC CE activates a second set of TCI states, and wherein the second MAC CE includes a second mapping that maps one or more TCI codepoints in DCI to one or more TCI states;
updating the set of activated TCI states and the mapping of TCI codepoints to TCI states only for the first or second plurality of CORESETs associated with the first or second index value indicated in the second MAC CE; and
maintaining the original set of activated TCI states and the mapping of TCI codepoints to TCI states for the first or second plurality of CORESETs associated with the index value indicated in the first MAC CE.

30. The apparatus of claim 23, further comprising:
receiving a second MAC CE, wherein the second MAC CE indicates the first index value or the second index values, wherein the second MAC CE activates a second set of TCI states, and wherein the second MAC CE includes a second mapping that maps one or more TCI codepoints in DCI to one or more TCI states;
updating the set of activated TCI states and the mapping of TCI codepoints to TCI states only for the first or second plurality of CORESETs associated with the first or second index value indicated in the second MAC CE; and
deactivating the original set of activated TCI states and mapping of TCI codepoints to TCI states for the first or second plurality of CORESETs associated with the first or second index value indicated in the first MAC CE.
